(19) United States
(12) Patent Application Publication
(10) Pub. No.: US 2011/0000049 A1
(43) Pub. Date: Jan. 6, 2011

(54) HINGE

(75) Inventor: Wen-Bin Shen, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/510,284

(22) Filed: Jul. 28, 2009

(30) Foreign Application Priority Data
Jul. 1, 2009 (CN) 200920305474.1

(51) Int. Cl. E05D 11/08; E05D 11/10

(52) U.S. Cl. 16/342; 16/319

(57) ABSTRACT

A hinge includes a shaft, a first connecting, a number of elastic rings, a fastener, a resilient member, and a second connecting member. The shaft includes a shaft body defining a thread portion for engaging with the fastener. Two separate fixing portions extend from a distal end of the shaft body, and distal ends of the fixing portions are riveted to the second connecting member. The first connecting member and the number of elastic rings are rotatably mounted to the shaft body. The resilient member is fixed to the shaft body, and located between the second connecting member and the fastener. When the fastener is adjusted along the shaft, the resilient member is deformed to resist against the fastener and the second connecting member.

### BACKGROUND

1. Technical Field

The disclosure relates to a hinge.

2. Description of Related Art

A collapsible device, such as a notebook computer, or a clamshell mobile phone, generally including a base and a cover often uses a hinge to interconnect the base and the cover. The hinge allows the cover to be rotatable with respect to the base, and to be folded with the base for saving space.

A hinge normally includes a shaft, a first element rotatably mounted to the shaft, a second element fixed to the shaft, a plurality of elastic rings rotatably mounted to the shaft, and a fastener. The first and second elements are fixed to the base and the cover of the collapsible device, respectively. The fastener is fixed to a distal end of the shaft, for preventing the plurality of elastic rings, the first and second elements from disengaging from the shaft. Elasticity of the plurality of elastic rings tightens the first and second elements, increasing friction between the first and second elements to maintain the cover at a determined angle with respect to the base. However, the elasticity of the plurality of elastic rings will also urges the fastener. Therefore, after long term usage, the fastener may be disengaged from the shaft resulting in loosening the hinge.

### BRIEF DESCRIPTION OF THE DRAWINGS

FIG. 1 is an assembled, isometric view of an exemplary embodiment of a hinge, the hinge including a first connecting member and a second connecting member.

FIG. 2 is an exploded, isometric view of the hinge of FIG. 1.

FIG. 3 is similar to FIG. 2, but viewed from another perspective.

FIG. 4 is an assembled, isometric view of the hinge of FIG. 3.

FIG. 5 is similar to FIG. 4, but showing the second connecting member being rotated an angle relative to the first connecting member.

### DETAILED DESCRIPTION

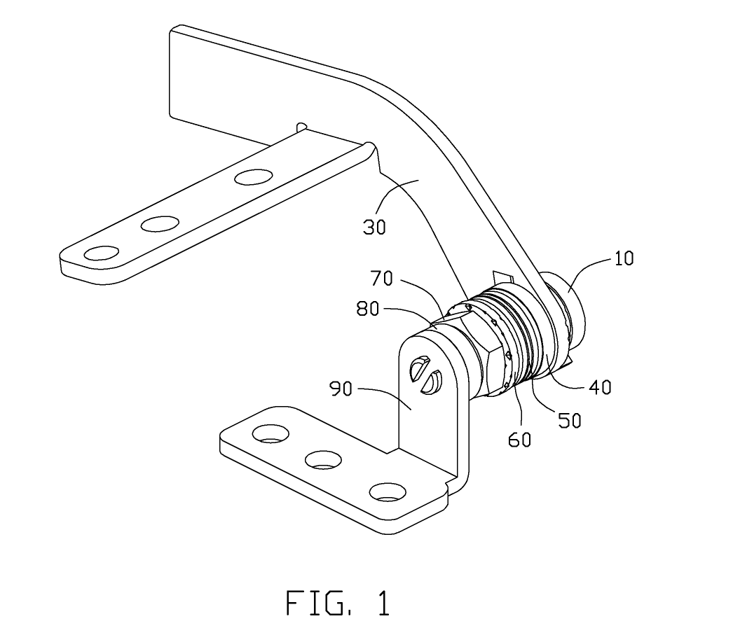

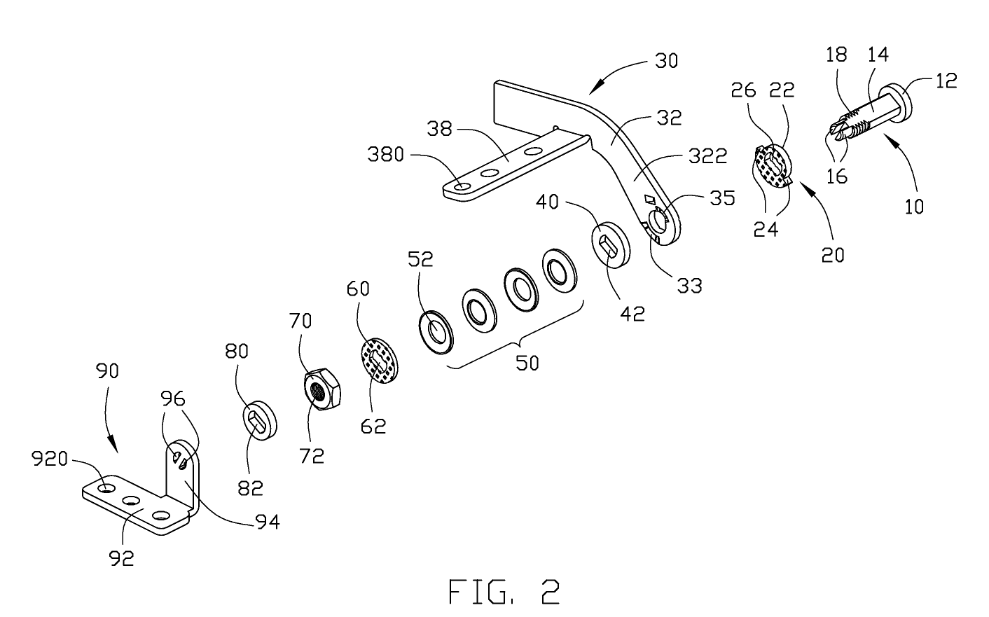

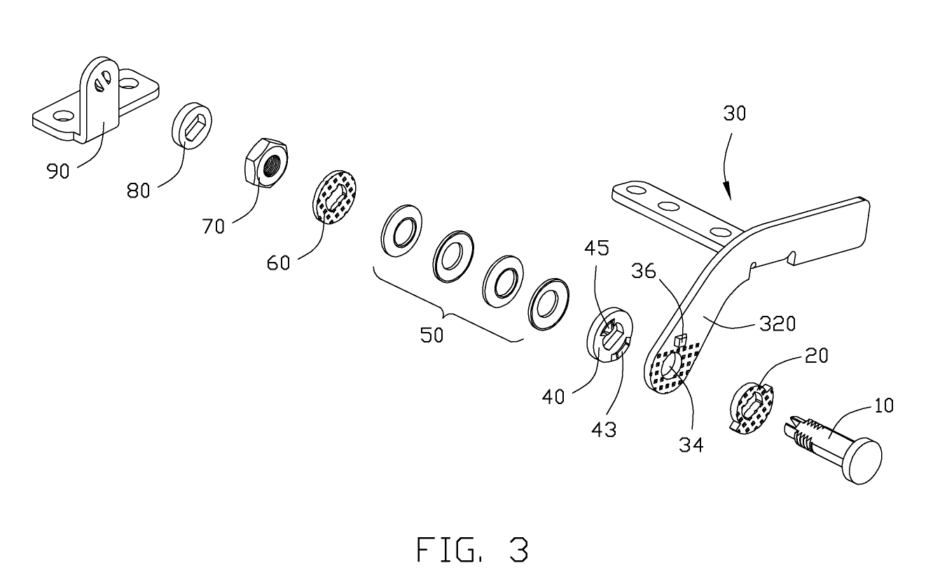

Referring to FIGS. 1 to 3, an exemplary embodiment of a hinge includes a shaft 10, a resisting member 20, a first connecting member 30, an interfering member 40, a plurality of elastic rings 50, a friction member 60, a fastener 70, a resilient member 80, and a second connecting member 90.

The shaft 10 includes a washer-shaped resisting portion 12 and a shaft body 14 extending from the resisting portion 12, the shaft body 14 having a double-D shaped cross-section. Two separate fixing portions 16 having a D shaped cross-section axially extend from a distal end of the shaft body 14, with a slot (not labeled) being defined between the two fixing portions 16. The shaft body 14 defines a threaded portion 18 on a circumference of the shaft body 14, adjacent to the fixing portions 16.

The resisting member 20 is generally washer-shaped, and defines an arc-shaped cutout 22 along a circumference of the resisting member 20, with two resisting surfaces 24 being formed at opposite ends of the cutout 22. The resisting member 20 defines a shaft hole 26 having a double-D shape in a center of the resisting member 20, corresponding to the shaft body 14 of the shaft 10, for unrotatably fitting about the shaft body 14.

The first connecting member 30 includes a fixing body 38 defining a plurality of fixing holes 380, and a curved pivoting portion 32 extending from an end of the fixing body 38. The pivoting portion 32 includes a first side 320 facing the resisting member 20, and a second side 322 opposite to the first side 320. The pivoting portion 32 defines a round through hole 34 through the first and second sides 320 and 322, for the shaft body 14 rotatably passing therethough. A protrusion 36 protrudes out from the first side 320, for selectionally resisting against one of the resisting surfaces 24 of the resisting member 20. A first depressed portion 33 and a second depressed portion 35 are defined in the second side 322 around the through hole 34, and opposite to each other across the through hole 34. The first depressed portion 33 extends along an edge of the pivoting portion 32, depart from the through hole 34, and the second depressed portion 35 extends along a cambered edge of the through hole 34. Each ends of the first and second depressed portions 33 and 35 has a slant portion (not labeled) extending to connect with the second side 322.

The interfering member 40 defines a fixing hole 42 having a double-D shaped cross-section, corresponding to the shaft body 14 of the shaft 10, for unrotatably fitting about the shaft body 14. A first raised portion 43 and a second raised portion 45 protrude out from the interfering member 40 around the fixing hole 42. The first raised portion 43 extends along an edge of the interfering member 40, corresponding to the first depressed portion 33. The second raised portion 45 neighbors the fixing hole 42, corresponding to the second depressed portion 35. Therefore, the first and second raised portions 43, 45 are correspondingly engaged in the first and second depressed portion 33, 35. Each ends of the first and second raised portions 43, 45 has a slant surface (not labeled) extending to connect with the interfering member 40.

Each elastic ring 50 defines a round through hole 52, allowing the shaft body 14 of the shaft 10 to rotatably pass therethrough.

The friction member 60 defines a double-D shaped through hole 62 in a center of the friction member 60, for unrotatably fitting about the shaft body 14 of the shaft 10.

In this embodiment, the fastener 70 is a nut, and defines a screw hole 72 in a center of the fastener 70, for engaging with the threaded portion 18 of the shaft 10.

The resilient member 80 defines a double-D shaped through hole 82 in a center of the resilient member 80, for unrotatably fitting about the shaft body 14 of the shaft 10. In this embodiment, the resilient member 80 is made of silica gel. In other embodiments, the resilient member 80 can be a coil spring.

The second connecting member 90 is generally L-shaped. The second connecting member 90 includes a connecting portion 92 defining a plurality of fixing holes 920, and a fixing portion 94 perpendicularly extending from a side of the connecting portion 92. The fixing portion 94 defines two fixing hole 96 each having a D shape, corresponding to the fixing portions 16 of the shaft 10 for fixing the fixing portions 16.

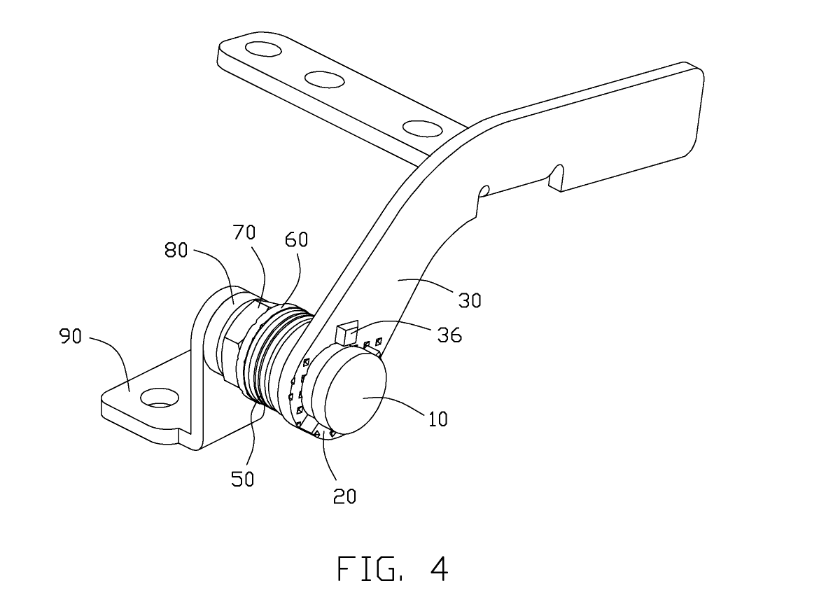

Referring to FIG. 4, in assembly, the shaft body 14 of the shaft 10 is unrotatably passed through the shaft hole 26 of the resisting member 20, the through hole 34 of the first connecting member 30, the fixing hole 42 of the interfering member 40, the through holes 52 of the plurality of elastic rings 50, the through hole 62 of the friction member 60, the screw hole 72 of the fastener 70, and the through hole 82 of the resilient member 80 one by one in that order, with the threaded portion 18 of the shaft body 14 engaging in the screw hole 72 of the fastener 70, and the fixing portions 16 are engaged in the fixing holes 96 of the second connecting member 90. Distal ends of the fixing portions 16 are riveted to the fixing portion 94 of the second connecting member 90. The resilient member 80 is deformed to resist against the fixing portion 94 and the fastener 70. In the aforementioned assembly, opposite sides of the resisting member 20 resist against the resisting portion 12 of the shaft 10 and the first side 320 of the pivoting portion 32 of the first connecting member 30, with the protrusion 36 of the first connecting member 30 being received in the cutout 22 of the resisting member 20. The first and second raised portions 43 and 45 of the interfering member 40 are engaged in the first and second depressed portions 33 and 35 of the first connecting member 30, correspondingly. The plurality of elastic rings 50 are deformed to provide elasticity along an axial direction of the shaft 10, to tighten the interfering member 40, the first connecting member 30, the resisting member 20, the friction member 60, and the fastener 70.

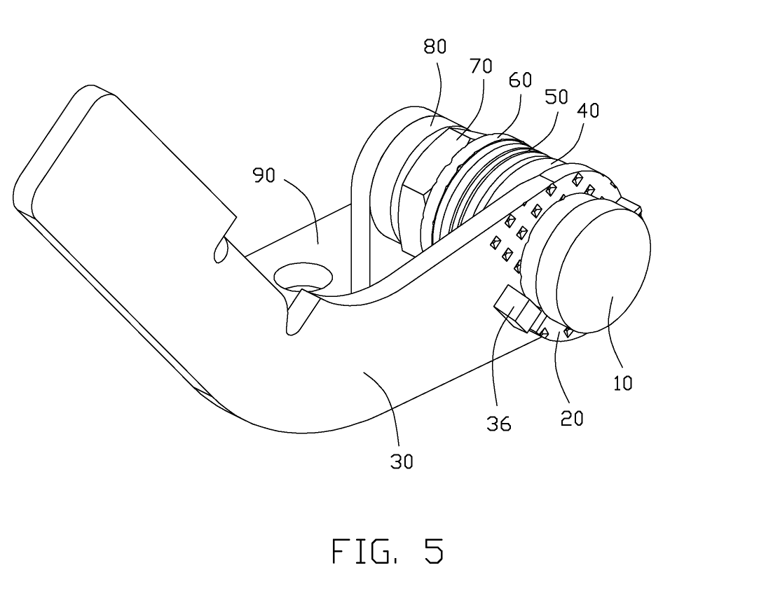

Referring to FIGS. 4 and 5, in use, the first connecting member 30 is rotated around the shaft body 14 of the shaft 10, relative to the second connecting member 90, the first and second raised portions 43 and 45 of the interfering member 40 slide out from the first and second depressed portions 33 and 35 to the second side 322 of the second connecting member 30. Correspondingly, the protrusion 36 of the first connecting member 30 rotates in the cutout 22 of the resisting member 20. When one of the resisting surfaces 24 of the resisting member 20 resists against the protrusion 36, the first connecting member 30 is stably maintained at a determined angle with respect to the second connecting member 90. Consequently, the first connecting member 30 cannot be rotated further.

In addition, the fastener 90 can be rotated along the threaded portion 18 of the shaft 10 to tighten or loosen the friction member 60, to adjust elasticity of the plurality of elastic rings 50. In this process, the resilient member 80 is deformed to resist the fastener 70, for preventing the fastener 70 from disengaging from the shaft 10.

It is believed that the present embodiment and its advantages will be understood from the foregoing description, and it will be apparent that various changes may be made thereto without departing from the spirit and scope of the description or sacrificing all of its material advantages, the example hereinbefore described merely being exemplary embodiment.

1. A hinge comprising:
a shaft comprising a shaft body defining a threaded portion on a circumference of the shaft body, two separate fixing portions extending from a distal end of the shaft body, the threaded portion located neighboring the fixing portions;
a first connecting member rotatably mounted to the shaft body;
a plurality of elastic rings rotatably mounted to the shaft body;
a fastener adjustably engaged with the threaded portion, wherein the fastener is operable to rotate along the threaded portion to tighten or loosen the plurality of elastic rings;
a second connecting member defining two separate fixing holes for fixedly receiving the corresponding fixing portions of the shaft; and
a resilient member defining a double-D shaped through hole, and the resilient member non-rotatably fixed to the shaft body with deformation through the through hole, and opposite sides of the resilient member contacting and resisting to resist against the fastener and the second connecting member; wherein distal ends of the fixing portions extend through the separate fixing holes and are riveted to the second connecting member for preventing the first connecting member, the plurality of elastic rings, the fastener, and the resilient member from disengaging from the shaft body.

2. The hinge of claim 1, further comprising a resisting member, wherein the resisting member, unrotatably mounted on the shaft body, defines a cutout along a circumference of the resisting member, two resisting surfaces are formed at opposite ends of the cutout, a protrusion protrudes out from the first connecting member to be slidably received in the cutout, to selectively resist against one of the resisting surfaces.

3. The hinge of claim 2, wherein the shaft further comprises a washer-shaped resisting portion at an end of the shaft body, opposite sides of the resisting member resist against the resisting portion and the first connecting member.

4. The hinge of claim 1, further comprising an interfering member unrotatably mounted on the shaft, wherein a first raised portion and a second raised portion protrude out from the interfering member, the first connecting member defines a first depressed portion and a second depressed portion engaged with the first and second raised portions, respectively.

5. The hinge of claim 4, wherein the interfering member defines a fixing hole for unrotatably fitting about the shaft body, the first raised portion extends along an edge of the interfering member, the second raised portion neighbors the fixing hole, each ends of the first and second raised portions comprises a slant surface extending to connect with the interfering member.

6. The hinge of claim 4, wherein the first connecting member defines a through hole to allow the shaft body to rotatably pass therethrough, the first and second depressed portions are opposite to each other across the through hole.

7. The hinge of claim 6, wherein the first depressed portion extends along an edge of the first connecting member, apart from the through hole of the first connecting member, and the second depressed portion extends along a cambered edge of the through hole of the first connecting member.

8. A hinge comprising:
a shaft comprising a resisting portion and a shaft body extending from the resisting portion;
a first connecting member rotatably mounted to the shaft body, a protrusion protrudes out from the first connecting member;
a second connecting member fixed to a distal end opposite to the resisting portion of the shaft body;
a resisting member fixed to the shaft body, and opposite sides of the resisting member abutting against the resisting portion of the shaft and the first connecting member, the resisting member comprising two resisting surfaces, wherein the first connecting member is rotated relative to the shaft, the protrusion selectively resisting against one of the resisting surfaces; and
a plurality of elastic rings rotatably mounted to the shaft body;
a fastener adjustably fixed to the shaft body; and
a resilient member defining a double-D shaped through hole, and the resilient member non-rotatably fixed to the shaft body through the through hole, and opposite sides of the resilient member abutting against the fastener and the first connecting member, wherein the resilient member is deformed to resist against the fastener, to prevent the fastener from disengaging from the shaft body.

9. The hinge of claim 8, further comprising an interfering member unrotatably mounted on the shaft, wherein a first raised portion and a second raised portion protrude out from the interfering member, the first connecting member defines a first depressed portion and a second depressed portion to engage with the first and second raised portions, respectively.

10. The hinge of claim 9, wherein the protrusion is opposite to the first and second depressed portions.

11. The hinge of claim 9, wherein the first connecting member defines a through hole allowing the shaft body to pass therethrough, the first and second depressed portions are opposite to each other across the through hole.

12. The hinge of claim 11, wherein the first depressed portion extends along an edge of the first connecting member, apart from the through hole, and the second depressed portion extends along a cambered edge of the through hole.

13. The hinge of claim 8, further comprising a friction member fixed to the shaft body, wherein opposite sides of the friction member resist against the fastener and the plurality of elastic rings.
